(19) United States
(12) Patent Application Publication
(10) Pub. No.: US 2010/0054205 A1
(43) Pub. Date: Mar. 4, 2010

(54) HANDOFF MANAGEMENT FOR MULTIMODE COMMUNICATION DEVICES BASED ON NON-TRAFFIC STATE UPLINK SIGNALS

(76) Inventor: Amit KALHAN, La Jolla, CA (US)

Correspondence Address: KYOCERA WIRELESS CORP., P.O. BOX 928289, SAN DIEGO, CA, 92192-8289, US

(21) Appl. No.: 12/202,917

(22) Filed: Sep. 2, 2008

(51) Int. Cl. H04Q 7/00

(52) U.S. Cl. 370/331

(57) ABSTRACT

An access node receives a non-traffic state WWAN uplink signal transmitted from a multimode wireless communication device to a base station. In response to the reception of the non-traffic state uplink signal, the base station transmits a search message to the multimode wireless communication device to adjust a searching scheme. The WWAN can be notified of the reception of the non-traffic state WWAN uplink signal by a device proximity message that is sent by the access node to the WWAN in response to the reception of the non-traffic state WWAN uplink signal.

### RELATED APPLICATIONS

This application is related to U.S. Patent Application entitled “HANDOFF MANAGEMENT BASED ON NON-TRAFFIC STATE UPLINK SIGNALS”, Ser. No. ______, docket number TUTL 00169 filed concurrently with this application and incorporated by reference in its entirety, herein.

### BACKGROUND

The invention relates in general to wireless communication systems and more specifically to managing handoffs of multimode wireless communication devices between wireless wide area networks (WWANs) to wireless local area networks (WLANs).

Wireless local area networks (WLANs) and wireless wide area networks (WWANs) provide wireless communication services to portable devices where the WLANs typically provide services within geographical service areas that are smaller than the geographical areas serviced by WWANs. Examples of WWANs include systems that operate in accordance with 2.5G (such as cdma2000), 3G (such as UMTS, WiMax), and other types of technologies, where each base station of the WWAN is typically designed to cover a service area having a size measured in miles. The term WWAN is used primarily to distinguish this group of diverse technologies from WLANs that typically have smaller service areas on the order of 100 to 300 feet per base station. Base stations in WLANs are typically referred to as access points, hotspot base stations, or access nodes. An access point may be connected to the Internet, intranet, or other network through wires or wirelessly through a WWAN. Examples of WLANs include systems using technologies such as Wi-Fi, WiMAX, HomeRF, HiperLAN/1, HiperLAN/2 and Open air as well as other wireless protocols in accordance with IEEE 802.11 standards. WLANs typically provide higher data-rate services than WWANs at the expense of non-ubiquitous coverage, whereas WWANs provide increased coverage areas at the cost of bandwidth and/or capacity. In order to provide a wireless user with the increased overall performance and continuous connectivity, multimode and dual-mode portable communication devices have been developed allowing the communication device to access the particular type of network that provides the most desirable tradeoffs. A multimode wireless communication device includes the appropriate components and functionality for communicating within more than one network. For example, a dual-mode portable communication device can communicate within a WWAN and a WLAN.

Unfortunately, conventional techniques for managing the connection status between the portable communication device and the access point are limited in that they require GPS location information or include inefficient searching mechanisms executed by the portable communication device in order to establish service with a new network for performing a handoff between networks. For example, some conventional systems require the multimode wireless communication device to periodically tune to an alternate network channel in an attempt to detect an alternate network resulting in significant power consumption with a limited success rate of detecting alternate networks. Activating a receiver to search for a WLAN during a non-traffic state such sleep state, dormant state, semi-connected state, or other power conserving mode, can significantly reduce battery life.

### SUMMARY

An access node receives a non-traffic state WWAN uplink signal transmitted from a multimode wireless communication device to a base station. In response to the reception of the non-traffic state uplink signal, the base station transmits a search message to the multimode wireless communication device to adjust a searching scheme for an access node WLAN signal. The adjustment in the searching scheme may be an activation of a searcher. The WWAN can be notified of the reception of the non-traffic state WWAN uplink signal by a device proximity message that is sent by the access node to the WWAN in response to the reception of the non-traffic state WWAN uplink signal.

### BRIEF DESCRIPTION OF THE DRAWINGS

FIG. 1 is a block diagram of a communication system arrangement in accordance with the exemplary embodiment of the invention.

FIG. 2A is an illustration of an exemplary geographical service area relationship provided by an base station and access node where the geographic service area of a access node is within an originating geographic service area of the base station.

FIG. 2B is an illustration of an exemplary geographical service area relationship provided by the base station and the access node where the geographic service area of a access node overlaps with the originating geographic service area of the base station.

FIG. 2C is an illustration of an exemplary geographical service area relationship provided by the base station and the access node where the geographic service area of a access node does not overlap with the originating geographic service area of the base station.

FIG. 3A is a block diagram of the search message.

FIG. 3B is block diagram of a device proximity message.

FIG. 4 is a block diagram of a communication system arrangement where the non-traffic state reverse link signal is an intercepted non-traffic state uplink (reverse link) cellular signal.

FIG. 5 is block diagram of a multimode wireless communication device communicating in a communication system arrangement including at least one WWAN and at least one WLAN.

FIG. 6 is flow chart of a method of managing wireless service to a multimode wireless communication device performed at the access node.

FIG. 7 is a flow chart of a method of managing communication services to the multimode wireless communication device performed in the system infrastructure.

FIG. 8 is a flow chart of method performed at the multimode wireless communication device after receiving the search message.

FIG. 9 is a flow chart of a method of managing communications performed at an access node such as a femtocell base station where the device proximity message is transmitted in response to receiving the non-traffic state uplink signal from an authorized multimode wireless communication device.

FIG. 10 is a flow chart of a method of managing communications where the proximity of the multimode wireless communication device to the access node is determined based on the non-traffic state uplink signal.

### DETAILED DESCRIPTION

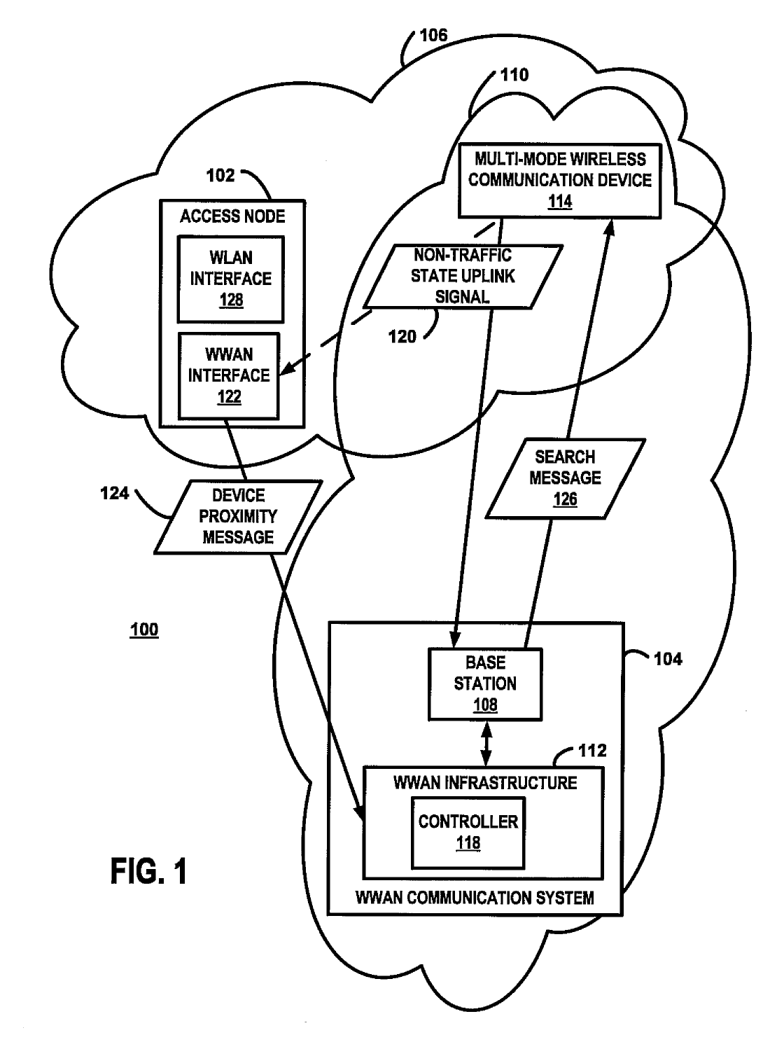

FIG. 1 is a block diagram of a communication system arrangement 100 including an access node 102 and a wireless wide area network (WWAN) communication system 104. The access node 102 is part of a wireless local area network (WLAN) 106 and includes communication equipment such as wireless transceiver for providing wireless services within the WLAN 106. The access node 102, therefore, is a WLAN base station or access point, for example. The WWAN communication system 104 includes one or more base stations 108 for providing WWAN services within a WWAN 110. The communication system arrangement 100 may be implemented in accordance with any of numerous technologies and communication standards. For the examples discussed below, the WWAN communication system 104 operates in accordance with a Code Division Multiple Access (CDMA) standard such as cdma2000 1X. Examples of other suitable communication standards include other CDMA standards such as 1xEV-DO and W-CDMA, OFDMA based standards such as WiMAX, and TDMA based standards such as GSM. The access node 102 uses a communication standard that is different from the standard used by the WWAN communication system 104 for the exemplary arrangements discussed herein. Examples of suitable access node 102 standards include IEEE standards such as WiFi, based on IEEE 802.11 standards, as well as other WLAN technologies such as Home RF, HiperLAN/1, HiperLAN/2 and Open air. The various functions and operations of the blocks described with reference to the communication system arrangement 100 may be implemented in any number of devices, circuits, and/or elements as well as with various forms of executable code such as software and firmware. Two or more of the functional blocks of FIG. 1 may be integrated in a single device and the functions described as performed in any single device may be implemented over several devices. For example, at least portions of the functions of the system infrastructure 112 may be performed by the base station 108, a base station controller, or a Mobile Switching Center (MSC) in some circumstances.

A multimode wireless communication device 114 is capable of communicating on both of the networks (WLAN 106 and WWAN 110). The multimode wireless communication device 114 can access wireless services provided by either of the WLAN 106, WWAN 110 networks when resources are available on the particular network and signal quality is adequate. For the examples discussed herein, the multimode wireless communication device 114 may access both networks 106, 110 simultaneously under certain conditions. In some circumstances, however, the multimode wireless communication device 114 may be able only to access one of the networks 106, 110 at any given time. In other scenarios, the multimode wireless communication device 114 may be able to access only control channels of the WWAN 110 but have full access to the WLAN 106 or vice versa.

The WWAN communication system 104 includes system infrastructure 112 that is connected to one or more base stations 108. Communications between the base stations 108 and the multimode wireless communication device 114 are at least partially managed by the system infrastructure 112. A controller 118 within the system infrastructure 112 includes hardware, software and/or firmware for receiving and sending control messages. The controller 118 may include at least portions of a BSC and a MSC. For the example discussed herein, the controller 118 is the equipment within the WWAN communication system 100 that performs wireless device paging functions and generates paging channel messages.

For the exemplary situation illustrated in FIG. 1, the multimode wireless communication device 114 is in a non-traffic state and communicating with a base station 108. In order to conserve power, the multimode wireless communication device 114 may be placed in one of at least two states that include a traffic state and a non-traffic state. During the traffic state (sometimes referred to as an active state), the multimode wireless communication device 114 can exchange, with the base station 108, control signals as well as communication signals including information such as voice and data signals. During the non-traffic state, a portion of the circuitry is turned off or placed in a low power state at least a portion of the time that the device is in the non-traffic state to conserve power. At least some transceiver circuitry, however, is at least periodically activated during the non-traffic state to exchange non-traffic state signals with the base station. The non-traffic state may include other states which may differ depending on the particular communication technology. The non-raffic state is a state where data traffic is not exchanged with the multimode wireless communication device and may be an idle state, a dormant state, a semi-connected state, a sleep state, or other such state. WWAN downlink signals, which are also referred to as WWAN forward link signals, are transmitted from base stations to multimode wireless communication devices. WWAN uplink signals, also referred to as WWAN reverse link signals, are signals transmitted from multimode wireless communication devices to the base station 108. Accordingly, non-traffic state uplink signals are signals transmitted from the wireless communication to the base station 108 when the multimode wireless communication device 114 is in a non-traffic state, such as an idle state or dormant state. Non-traffic state downlink signals are signals transmitted from the base station 108 to the multimode wireless communication device when the multimode wireless communication device 114 is in a non-traffic state such as the idle state or dormant state. Examples of non-traffic state downlink signals include paging signals, control signals (e.g. synchronization signal), and network update signals. Examples of non-traffic state uplink signals include signals that convey information related to a handoff procedure, an acknowledgement procedure, a registration procedure and a resynchronization procedure a network access request and a response message transmission.

When the multimode wireless communication device 114 is sufficiently close to the access node 102, the access node 102 can receive the non-traffic state uplink signals 120 transmitted by the multimode wireless communication device 114 to the base station 108. The access node 102, therefore, eavesdrops on the uplink channels used by one or more multimode wireless communication devices 114. A WWAN receiver (not shown in FIG. 1) within a WWAN interface 122 at the access node 102 is tuned to the appropriate code channel and/or frequency to intercept the non-traffic state uplink signal 120. For the example, the access node 102 has access to the WWAN system timing. In some circumstances, the access node 102 may derive the WWAN timing by eavesdropping on downlink signals transmitted by the base station 108. The access node 102 may also derive the WWAN timing from the system infrastructure 112 through a backhaul (not shown in FIG. 1) connecting the access node 102 to the WWAN system 104. Accordingly, the access node 102 has sufficient timing information to determine the time slot boundary and the timing of uplink signals. In some circumstances, the access node 102 may only search for multimode wireless communication devices that are authorized to use the access node 102. An authorized list of serial numbers or other device identifiers are stored in memory at the access node 102. The non-traffic state uplink signal 120 is shown as a solid line to the base station 108 and as a dashed line to the access node 102 to illustrate that the non-traffic state uplink signal 120 is transmitted to the base station 108 by the multimode wireless communication device 114 for reception by the base station 108 and that the access node 102 is eavesdropping on the channel.

In response to successfully receiving the non-traffic state uplink signal 120, the access node 102 sends a device proximity message 124 to the controller 118 which invokes the base station 108 to transmit a search message 126 to the multimode wireless communication device 114. Although the controller 118 is illustrated as part of the system infrastructure 102, it may be part of the base station 108 or collocated with the base station 108. The controller 118 may include, or may be part of, the MSC, BSC or other infrastructure. As discussed above, the controller 118 includes the hardware and software for generating the search message 126 and, for this example, is the same equipment used to generate paging channel messages. The search message 126 triggers an adjustment of the multimode wireless communication device searching scheme that the multimode wireless communication device 114 employs for searching for WLAN service. For the examples herein, the search message 126 includes an instruction to turn on or otherwise activate a WLAN receiver in the WWAN interface. Other search parameters may be included such as the frequencies to be searched or other information regarding the access node communications that allow the multimode wireless communication device 114 to search in a manner that maximizes the probability of detecting signals transmitted by the access node 102. Accordingly, the multimode wireless communication device 114 turns on, or otherwise activates, the WLAN receiver and may change one or more searching parameters of the searching scheme in response to receiving the search message 126. For the example, the search message 126 is transmitted using the paging channel. Any suitable downlink channel monitored by the multimode wireless communication device 114 during the non-traffic state, however, may be used.

For the present example, the device proximity message 124 is sent in response to receiving the non-traffic state uplink signal 120 from an authorized user of the access node 102. The search message 126 is sent to the multimode wireless communication device 114 in response to receiving the device proximity message 124 at the controller 118. In some situations, however, additional criteria may be evaluated before sending the device proximity message 124, the search message 126, or before sending both. As discussed below, the access node 102 may evaluate one or more parameters to determine the proximity of the multimode wireless communication device 114 to the access node 102 and only send the device proximity message 124 if the calculated proximity is less than a threshold. Also, the controller 118 may evaluate system conditions and refrain from sending the search message 126 if certain system conditions are not met.

Examples of data that may be evaluated by the access node 102 include the capacity of the access node 102, bandwidth requirements of the multimode wireless communication device 114, and a calculated or estimated proximity of the multimode wireless communication device 114 to the access node 102. Accordingly, the access node 102 may evaluate a characteristic of the non-traffic state uplink signal 120 to determine whether to transmit the device proximity message 124. In the example, the reception of the non-traffic state uplink signal 120 by the receiver 114 is sufficient to determine that the multimode wireless communication device 114 is present and that the device proximity message 124 should be transmitted. In other circumstances, other signal characteristics may be evaluated to determine the proximity. Therefore, a characteristic of the non-traffic state uplink signal 120 may be any of numerous parameters with any of numerous thresholds depending on the particular implementation and the characteristic may be the adequacy of the non-traffic state uplink signal 120 to be detected by the access node WWAN receiver. Examples of other characteristics include a signal to noise ratio (SNR), bit error rate (BER), power level, signal propagation time, and presence of particular data. An example of technique for determining the proximity is discussed in U.S. patent application Ser. No. 11/565,266 entitled “APPARATUS, SYSTEM AND METHOD FOR MANAGING WIRELESS LOCAL AREA NETWORK SERVICE TO A MULTIMODE PORTABLE COMMUNICATION DEVICE”, filed on Nov. 30, 2006, and incorporated by reference in its entirety herein. For the examples discussed herein, the characteristic of the signal is the adequacy of the non-traffic state uplink signal 120 to be demodulated and decoded by the access node 102 using a long code mask corresponding to authorized users of the access node 102. Although the access node 102 may not be able to decode the information on the uplink signal, the access node 102 may recognize the user using the long-code mask or other identifying information within the signal.

The device proximity message 124 and search message 126 may have any of numerous relationships and each message may be dependent on the information within, the format of, and/or other characteristics of the other message. For example, the device proximity message 124 and the search message 126 may be the same message in some circumstances, Such a situation occurs where the device proximity message 124 is an SMS message sent directly from the access node 102 to the multimode wireless communication device 114 indicating that a non-traffic state uplink signal 120 transmitted from the device 108 has been detected by the access node 102. The multimode wireless communication device 114 interprets the device proximity message 124 as a search message 126 indicating that the WLAN receiver within the multimode wireless communication device 114 should be activated. Transmitting the search message 126 within the paging channel, however, allows for minimizing power consumption since additional resources are not invoked to receive SMS messages.

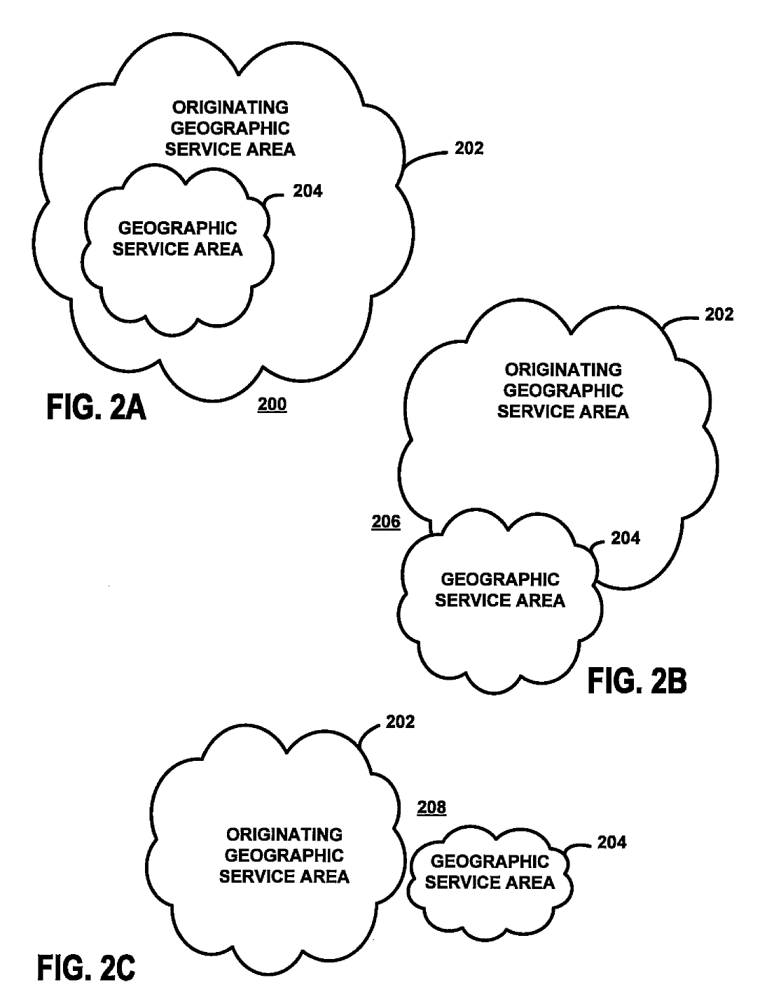

The base station 108 provides wireless services within a base station geographical service area and the access node provides wireless services within a WLAN geographic service area where the areas are sometimes referred to as cells. As discussed below with reference to FIG. 2A, FIG. 2B, and FIG. 2C, the base station 108 provides wireless service within a geographical service area that may overlap, completely surround, or be separate from the WLAN geographical service area of the access node.

After receiving the search message 126, the multimode wireless communication device 114 searches for WLAN signals in accordance with the adjusted search scheme. In response to the search message, the multimode wireless communication device activates the appropriate circuitry to receive signals transmitted by the access node 102 such as a beacon pilot signal or communication pilot signals. For the example, the receipt of the search message 126 triggers the activation of the WLAN receiver in the multimode wireless communication device 114. In some situations, however, receiver circuitry is periodically activated in accordance with the search scheme and the search message 126 does not directly trigger the activation of the receive circuitry. In such situations, the search message may adjust the search scheme which may result in more frequent activation of the receive circuitry or activate a different technology hardware to search for WLAN signal. The access node 102 generates and transmits a communication pilot signal which provides control and timing information to the multimode wireless communication device 114. In some circumstances, the access node 102 may refrain from transmitting WLAN pilot signals until a multimode wireless communication device 114 is detected and the proximity message is sent. In addition, the access node 102 may transit a beacon pilot signal in some situations. After the access node 102 is detected by the multimode wireless communication device 114, the multimode wireless communication device 114 may engage in a handoff procedure where, after a determination that the multimode wireless communication device 114 should be handed off to the access node 102, the WLAN establishes wireless service to the multimode wireless communication device 114 from the access node 102.

FIG. 2A, FIG. 2B and FIG. 2C are depictions of exemplary geographical service area relationships 200, 206, 208 provided by the base station 108 and the access node 102. A WWAN geographical service area 202 provided by the base station 108 and a WLAN geographic service area 204 provided by the access node 102 may have any of numerous shapes, sizes, and configurations. Accordingly, the clouds representing the service areas generally illustrate the relationships between the service areas and do not necessarily depict the actual shapes of the service areas. Further, the service areas may contain holes of coverage where service is unavailable. In the interest of clarity and brevity, such features are not illustrated in the figures. In FIG. 2A, the service area 204 of the access node 102 is completely within the service area 202 provided by the base station 108. Such service area relationships 200 often occur where base stations within the communication system arrangement provide WWAN coverage within relatively large service areas and the access nodes provides smaller service regions sometimes referred to hot spots at a residence, restaurant, business, park, shopping mall or other regions where a user may roam. In a WiFi arrangement for a residence, for example, an access node 102 located at the residence provides wireless services for devices used by users living at the residence or are otherwise authorized to use the WLAN. When the multimode wireless communication devices are outside the service area 204, service is provided by larger WLAN macrocells established by base stations 106. When the authorized multimode wireless communication device is at the residence, however, WLAN service can be provided by the access node. Accordingly, in most situations, the WLAN service area 204 of the access node 102 will be completely within the WWAN service area 202 of the base station 108. In some situations, however the WLAN service area 204 may be partially overlapping with the WWAN service area 202 as shown in FIG. 2B or may be non-overlapping but adjacent to the WWAN service area 202 as shown in FIG. 2C.

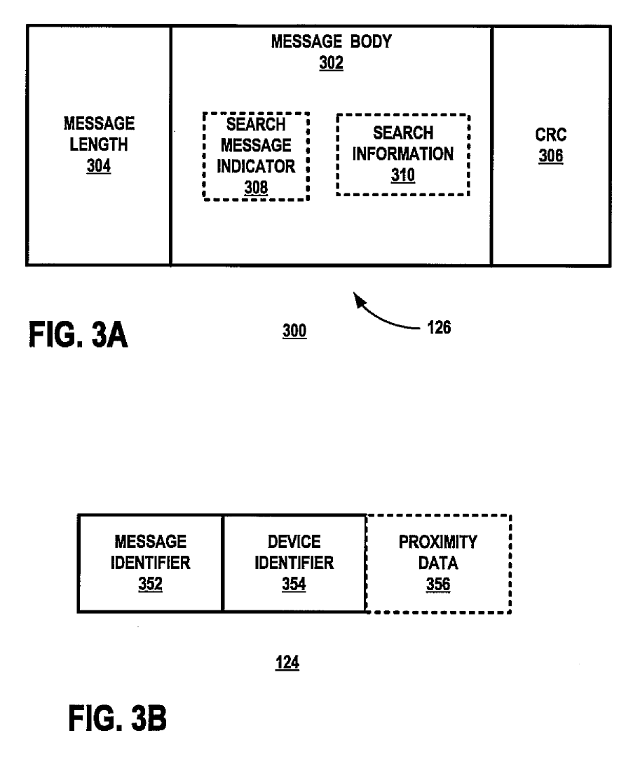

FIG. 3A is a block diagram of the search message 126 where the search message 126 is transmitted within a paging channel message 300. The search message 126 may contain any of several types of information, may have any of numerous formats, and may be transmitted using a variety of channels and signals. For this example, the search message 126 is contained within the message body 302 of a paging channel message 300 in accordance with one or more CDMA standards. A CDMA paging channel message is typically included within a PC message capsule where each paging channel message 300 includes a message length field 304, a message body 302, and a cyclic redundancy check (CRC) 306.

For the example, the search message 126 includes a search message indicator 308 and search information 310 disposed within the message body 302. The search message indicator 308 is any number of bits that indicates to the multimode wireless communication device that the paging message is a search message 126. The search information includes information related to the search scheme adjustment. In some cases, the search message indicator is sufficient to notify the multimode wireless communication device of a need to adjust the searching scheme and the search information 310 may be omitted. The search information 310, however, may include any of numerous parameters related to the adjusting the searching scheme. As discussed below in further detail, the search information 310 may include information that identifies an access node that should be searched or frequencies that should be searched.

The search message 126 includes information that results in an adjustment of one or more of the search parameters. For the example, the search message at least includes an indicator that, when interpreted by the multimode wireless communication device, indicates that the WLAN receiver within the multimode wireless communication device should be turned on in order to search for WLAN signals. In some situations, the search message 126 may only indicate that a more robust search should be performed and the multimode wireless communication device adjusts searching resources in response. For example, if the multimode wireless communication device 114 employs a WLAN searching scheme that includes periodically activating a WLAN receiver, the search message may invoke a more frequent activation of the WLAN receiver search, expand the search space, etc. In some situations, the WLAN receiver is not activated until the instructed by the search message.

The search message 126 may also include information 310 identifying a group of access nodes that may be available. Such an indication may be a specific identifier specifically identifying one or more access nodes or may be a general identification identifying a group of access nodes such as an identifier indicating all authorized using a particular standard. In some circumstances, the search message 126 may indicate specific frequencies. A pilot frequency or beacon frequency of the access node may be identified, for example.

Therefore, the multimode wireless communication device 114 extracts the information from the search message and adjusts the searching scheme in accordance with search message 126. For the example, the device activates the WLAN receiver in response to the search message 126. The search message 126 may result in the adjustment of any number search parameters, however, where some examples include adjusting one or more of the following: frequencies searched, channels searched, period between searches, period between searches of specific frequencies, time period of search, time period for search at specific frequencies, search offsets, location of starting search in the search-space, and searcher receiver settings. The parameters may also include the timing of the activation of the new searcher.

FIG. 3B is block diagram of a device proximity message 124 that includes a message identifier 352, and a device identifier 354. In some cases, proximity data 356 may also be included. The proximity data 356 is illustrated with dashed lines to indicate that this feature is optional. When included the proximity data 356 may indicate a calculated or estimated proximity, information that allows calculation of the proximity, a likelihood the device 114 is within the service area of the access node 102. The device proximity message 124 may have any of numerous formats and may be sent using any suitable signaling method. The message identifier 352 includes any combination of data that indicates to the controller 118 that the message 124 is a device proximity message 124. Accordingly, the message identifier 352 may be a single bit flag in some circumstances. The device identifier 354 includes data that identifies the multimode wireless communication device 114 that has been detected by the access node 102. One example of a device identifier 354 is a device serial number.

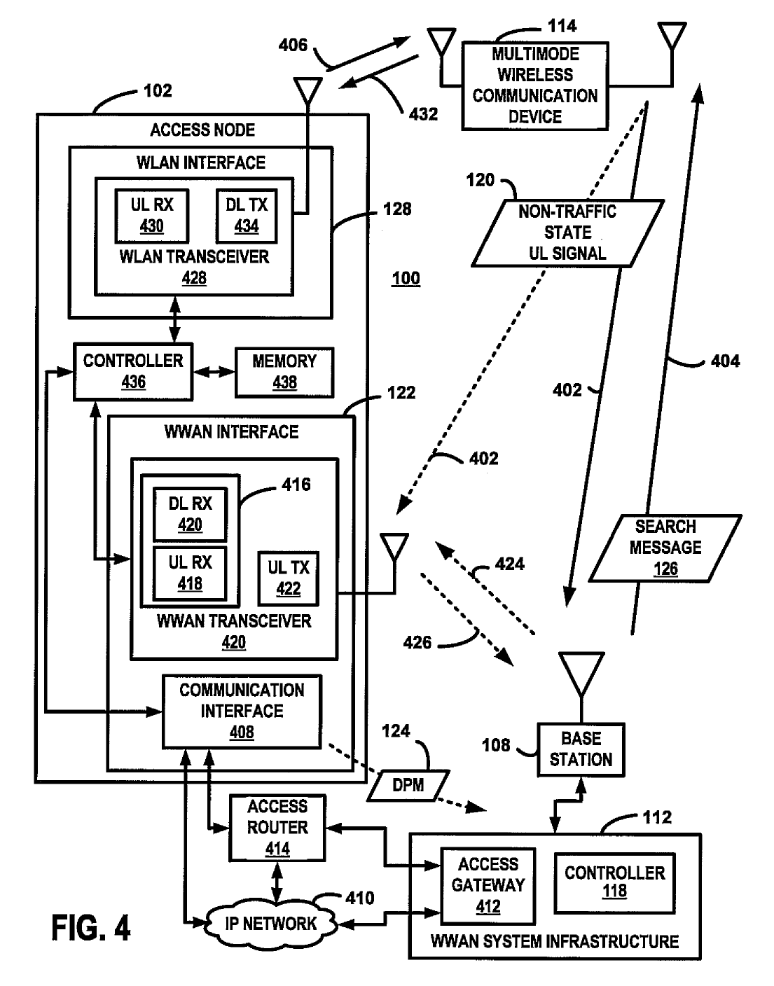

FIG. 4 is a block diagram of the communication system arrangement 100 where the non-traffic state uplink signal 120 is an intercepted non-traffic state uplink (reverse link) cellular signal 402 transmitted to a cellular base station 108 while the multimode wireless communication device 108 is in a non-traffic state. The system arrangement 100 may be implemented using any variety of communication technologies and cell sizes. For the example discussed with reference to FIG. 4, the access node 102 provides WLAN wireless service and the base station 108 provides WWAN service within a cellular WWAN macrocell. The base station 108 operates in accordance with CDMA protocols and standards and the access node operates in accordance with WLAN standards and protocols. As explained above, WLANs typically provide services within geographical service areas that are smaller than the geographical areas serviced by WWANs. Examples of WWANs include systems that operate in accordance with 2.5G (such as cdma2000), 3G (such as UMTS, WiMax), and other types of technologies, where each base station of the WWAN is typically designed to cover a service area having a size measured in miles. The term WWAN is used primarily to distinguish this group of diverse technologies from WLANs that typically have smaller service areas on the order of 100 to 300 feet per access node (access point or base station). The functional blocks of FIG. 4 may be implemented using any combination of hardware, software and/or firmware. Two or more of the functional blocks may be integrated in a single device and the functions described as performed in any single device may be implemented over several devices. For example, at least portions of the functions of the system infrastructure 112 and controller 118 may be performed by the base station 108, a base station controller, or an MSC in some circumstances.

The base station 108 transmits forward link (downlink) signals 404 to, and receives reverse link (uplink) signals 402 from, one or more multimode wireless communication devices 108 to provide wireless communication service. For the example of FIG. 4, the signals 402, 404 are non-traffic state signals that are transmitted while the multimode wireless communication device is in the non-traffic state. Signals are also exchanged when the multimode wireless communication device 114 is in the traffic or “active” state where the traffic signals include communication information such as data or voice. The access node 102 receives the non-traffic state uplink signal 120 by eavesdropping on the uplink channel used by the multimode wireless communication device 114. The access node 102 transmits a detectible downlink signal 406 that is detected by the multimode wireless communication device 114 after the wireless communication searches for the access node 102.

The system infrastructure 112 includes the controller 118 that may be implemented as a mobile switching center (MSC), a combination of an MSC and base station controllers (BSCs), or other similar communication controllers and/or servers. The controller 118 is connected to the cellular base stations 108 through the system infrastructure 112 and manages communications within the cellular system. A communication interface 408 within the access node 102 facilitates communication with an IP network 410. The communication interface 408 provides packet data communications and facilitates access to the Internet and to an access gateway 412 in the system infrastructure 112 through the access router 414 or directly through the IP network 410. The access router 414 may be connected to more than one access node 102 in some circumstances and provides communication management and control functions to the access node 102. In some situations, the access router 414 may be implemented within the access node 102 or may be eliminated. In some circumstances, the connection between the access gateway 412 and the base station 108 may include a wireless communication link such as satellite communication link or point-to-point microwave link, for example. Also, in some situations, circuit switched connections may be used to connect the access node 102 to the system infrastructure 112. In a typical arrangement, the access node 102 is connected to the Internet through an Internet Service Provider (ISP) service provided by a digital subscriber line (DSL) or CATV connection. Accordingly, the access router 414 is a DSL modem or cable modem in the typical arrangement. In the example, therefore, the system infrastructure 112 comprises a packet switched core network that includes at least one access gateway 412. The access gateway 412 is a communication interface that allows the base station 108 to communicate with the system infrastructure 112.

For the example, the WWAN infrastructure 112 comprises a packet switched core network that includes at least one access gateway 412. The access router 414 may be connected to the access gateway 412 using any combination of wired and wireless connections. Examples of suitable connections include T1 lines, fiber optic cable, coaxial cable, and point-to-point microwave, The access gateway 412 is a communication interface that allows the access node 102 to communicate with the WWAN infrastructure 112.

The multimode wireless communication device 114 is any type of communication device that is capable of communicating with the access node 102 and the base station 108. The multimode wireless communication device 114 can access wireless services provided by either of the networks when resources are available on the particular network and signal quality is adequate. In the exemplary embodiment, the multimode wireless communication device 114 may access both the cellular system (WWAN 110) and WLAN network 106 simultaneously under certain conditions. In some circumstances, however, the multimode wireless communication device 114 may be able only to access one of the networks at any given time. In another scenarios, the multimode wireless communication device 114 may be able to access only control channels of the WWAN network 110 but have full access of WLAN network 106 or vice versa. The multimode wireless communication device 114, sometimes referred to as an access terminal, may be a wireless modem, a personal digital assistant (PDA), cellular telephone, or other such device.

The access node 102 includes the WWAN interface 122 for communicating with the WWAN system 112, receiving the uplink WWAN signal 402 and for transmitting the device proximity message 124. In the exemplary embodiment, the WWAN interface 122 includes the communication interface 408, a WWAN receiver 416 that includes a WWAN uplink receiver (WWAN UL receiver) 418 and a WWAN downlink receiver (WWAN DL receiver) 420. The WWAN transceiver may also include an uplink WWAN transmitter (WWAN UL TX) 422 which may be used for transmitting information to the system infrastructure 112 in addition to, or alternatively to, communicating through IP network 410. The WWAN downlink receiver 420, therefore, receives WWAN downlink signals 424 transmitted by the base station 108 and the WWAN uplink transmitter 422 transmits WWAN uplink signals 426 to the base station 108.

The WLAN interface 128 provides WLAN service to one or more WLAN communication devices such as the multimode wireless communication device 114. The WLAN interface 128 typically includes a WLAN transceiver 428 where a WLAN uplink receiver 430 receives WLAN uplink signals 432 and a WLAN downlink transmitter 434 transmits downlink signals 406. The signals 406, 432 are transmitted and received in accordance with a WLAN protocol. Examples of a suitable WLAN protocols include protocols in accordance with the IEEE 802.11 protocol and wireless fidelity (WiFi). In some circumstances, the access node 102 may also include a wired LAN interface (not shown) for communicating with devices connected to the access node 102 through wires.

The access node 102 further comprises a controller 436 coupled to the WWAN interface 128 and the WLAN interface 122. The controller 436 performs the control functions described herein as well as performing other functions and facilitating the overall operation of the access node 102. The controller 436 is connected to, or includes, a memory 438 that may include one or more random access memory (RAM) and/or read only memory (ROM) memory devices.

As explained above, the WWAN interface 122 includes a WWAN receiver 416 that can be configured to at least to receive uplink WWAN signals 402 transmitted from a multimode wireless communication device 114. The WWAN interface 122 may also be configured to send the device proximity message signal 124 to the WWAN system through a WWAN uplink channel by transmitting the message as a WWAN uplink signal 426 using the WWAN uplink transmitter 422. For the example, the WWAN receiver 416 can be configured as the uplink WWAN receiver 418 for receiving the uplink WWAN signals 402 and as the downlink WWAN receiver 420 for receiving WWAN downlink signals 424 from the base station 108. In some circumstances, two separate WWAN receivers may be used to implement the functions of the WWAN uplink and downlink receivers 418, 420 while in other situations, the same receiver may be tuned to different frequencies to perform the functions of the two receivers (418, 420).

In addition to other information, the memory 438 stores communication device identification values corresponding to each communication device 114 that is authorized to receive service from the access node 102. The communication device identification value may include an electronic serial number (ESN), Mobile station Equipment Identifier (MEID) or International Mobile Subscriber Identity (IMSI) or other unique data identifying the multimode wireless communication device 114. An example of a group of identification values stored in memory 438 includes a collection of ESNs corresponding to the communication devices of the family members of a household where the access node 102 provides service. The identification values may be stored at the access node 102 using any of numerous techniques. An example of a suitable method of storing the values includes storing the values during an initialization procedure performed when the access node 102 is installed. The identification values may be provided, at least partially, by the core network or the cellular base station 108 in some circumstances. In some implementations, the identification values may be omitted or the access node may allow communication devices that do not have corresponding identification values stored at the access node 102 to receive service from the access node 102. As discussed below, the ESNs are used to generate long code masks such as public long code masks (PLCMs) which allow the access node to receive signals from the multimode wireless communication device 114 having the particular ESN. Other information may be received from the core network to generate the PLCMs in accordance with known techniques. In some situations, the core network, or base station may assign the PLCM to a particular multimode wireless communication device 114. The assigned PLCM value is stored in the base station 108. Also, a private long code mask may be used instead of, or in addition to, the PLCM in some cases. The identification information may be embedded in, or part of, the uplink signal such as the pilot, beacon, preamble, portion of data.

When the multimode wireless communication device 114 is in a non-traffic state, such an idle state, the downlink signals 404 are transmitted using a non-traffic state channel such as a WWAN paging channel, the quick paging channel or other channel that carry signals such as control signals, and network update signals. The multimode wireless communication device 114 transmits non-traffic state uplink signals 120 such as signals that convey information related to a handoff procedure, an acknowledgement procedure, a registration procedure and a resynchronization procedure a network access request and a response message transmission when in the non-traffic state.

During operation, the access node 102 monitors, at least periodically, a wireless channel that may include the non-traffic state uplink signal 120. The non-traffic state uplink signal 120 may be any non-traffic state signal transmitted by the communication device 114, including but not limited to, registration messages, acknowledgement messages, and other signaling messages transmitted from the multimode wireless communication device 114 during the non-raffic state. For the example of FIG. 4, the detection base station 108 monitors the uplink cellular channel used for transmitting non-traffic state signals from multimode wireless communication devices 114 to the base station 108. The WWAN uplink receiver 418 is tuned to the appropriate channel or channels to detect the uplink signal 402 transmitted by the multimode wireless communication device 114. For the example, the uplink receiver 418 sufficiently demodulates and decodes uplink signals to identify the long code mask. The long code mask is typically a 42 bit binary number that is unique to the multimode wireless communication device 114. The received signals are compared to a list of long code masks to determine if the signal was transmitted by an authorized multimode wireless communication device 114. As described above, the authorized multimode wireless communication devices are identified by device identifiers stored in memory. The identifiers either directly, or indirectly, correspond to long code masks that facilitate reception of the signals transmitted by the authorized devices in the exemplary embodiment. Typically, the PLCM is derived from a permutation of the bits of the ESN. PLCM may also be based on the Mobile station Equipment Identifier (MEID) or the International Mobile Subscriber Identity (IMSI). The access node can identify authorized users by demodulating and decoding the non-traffic state signal, extracting the device identifier and comparing the value to authorized device identifiers stored in memory. In some situations, the access node 102 evaluates one or more characteristics of the uplink signal to determine if the multimode wireless communication device transmitting the signal is within the service area of the access node 102 or at least whether the device is possibly within the service area of the access node 102. Examples of techniques that can be used to determine proximity of the multimode wireless communication device 114 to the access node 102 are discussed in the referenced U.S. patent application Ser. No. 11/565,266. For this example, the controller 436 determines if the non-traffic state uplink signal 120 (WWAN uplink signal 402) is successfully received at the access node 102. If the signal can be received, the controller 436 determines that the multimode wireless communication device 114 is sufficiently close to receiving service from the access node 102. In some cases, the uplink signal may be detected and received even though the multimode wireless communication device 114 is not within the service area of the access node 102. In these circumstances, the multimode wireless communication device 114 may unsuccessfully attempt to acquire service from the access node 102 after receiving the search message 126 from the base station 108.

In some situations, the determination of whether to transmit the device proximity message 124 may be based on other characteristics of the non-traffic state uplink signal in addition to the detection of the non-traffic state uplink signal. For example, the proximity of the multimode wireless communication device 114 to the access node 102 may be calculated or estimated based on characteristics of the non-traffic state uplink signal 120 and the device proximity message 124 may be transmitted only when the estimated proximity is less than a proximity threshold. Examples of detection signal characteristics include a signal to noise ratio (SNR), bit error rate (BER), frame error rate (FER), packet error rate (PER), power level, and signal travel time.

In some circumstances, the controller 436 determines, or at least estimates, the proximity of the authorized multimode wireless communication device 114 to the access node 102 based on one or more characteristics of the uplink signal. In the exemplary embodiment, the detection of an uplink signal from the communication device 114 is sufficient to determine that the communication device 114 is within a proximity range. The proximity is used to determine whether the communication device 114 is possibly within range of the access node 102 and at least possibly able to receive communication service from the access node. Therefore, the controller 436 at least determines whether the communication device is possibly within range of the access node 102. If the controller 436 determines that the multimode wireless communication device 114 is possibly in range, the device proximity message 124 is sent to the controller 118 in the WWAN system infrastructure 112 which results in the transmission of the search message 126 to the multimode wireless communication device 114. Examples of techniques that can be used to determine proximity of the multimode wireless communication device 114 to the access node 102 are discussed in the referenced U.S. patent application Ser. No. 11/565,266.

The controller 436 may determine whether to transmit the device proximity message 124 based on factors other than proximity of the multimode wireless communication device 114 or the detection of the non-traffic state uplink signal 120. For example, factors may include the available capacity of the access node 102, core network requirements, required bandwidth of the multimode wireless communication device communications, and availability of other base stations or communication service providers in the area. Accordingly, the access node 102 may not transmit the device proximity message 124 even if the multimode wireless communication device is within range in some circumstances. In some situations, the device proximity message 124 is transmitted every time a multimode wireless communication device is detected by the access node 102 and the system infrastructure 112 determines whether to transmit the search message 126.

The device proximity message is generated by the controller 436 and transmitted through the communication interface 408, through the IP network 410 and/or the access router 414 to the access gateway 412. The access gateway 412 routes the device proximity message through the system infrastructure 112 to the controller 118. As described above, for the discussed example, the controller 118 is the same equipment that is used to generate paging messages to the multimode wireless communication device 114. The controller 118 receives the device proximity message 124 and extracts the appropriate information. In response to the device proximity message 124, the controller 118 generates the search message 126 which is transmitted from the base station 108 to the multimode wireless communication device 114. As discussed above, the search message 126 triggers an adjustment of the multimode wireless communication device searching scheme that the multimode wireless communication device 114 employs for searching for WLAN service. For the example, the search message 126 invokes the activation of the WLAN uplink receiver 418. In some circumstances, the search message 126 may specifically instruct the multimode wireless communication device 114 to search for the particular access node 102 that detected the up link signal or may identify particular channels and/or frequencies that should be searched.

Therefore, the access node 102 includes a wireless local area network (WLAN) interface 128 configured to exchange WLAN signals with a multimode wireless communication device and a wireless wide area network (WWAN) interface 122 configured to detect a non-traffic state uplink signal transmitted to the WWAN from the multimode wireless communication device 114 while the multimode wireless communication device 114 is in a non-traffic state. The WWAN base station 108 is configured to transmit the search message 126 instructing the multimode wireless communication device 114 to search for an access node signal in response to the access node 102 receiving the non-traffic state uplink signal 120. For the example, the WWAN system infrastructure 112 is notified of the reception of the non-traffic state uplink signal 120 by the device proximity message 124 received from the access node at the controller 118, either wirelessly or through the backhaul, and which at least indicates that the non-traffic state uplink signal 120 was received from the multimode wireless communication device 114 at the access node 102. The device proximity message 124 invokes transmission of the search message 126 instructing the multimode wireless communication device 114 to adjust a search scheme for an alternate access node. In the example, the search message 126 instructs the multimode wireless communication device 114 to activate or otherwise enable the WLAN receiver 430. The search message 126 is sent through a non-traffic state downlink channel, such as paging channel, monitored by the multimode wireless communication device 114 during the non-traffic state.

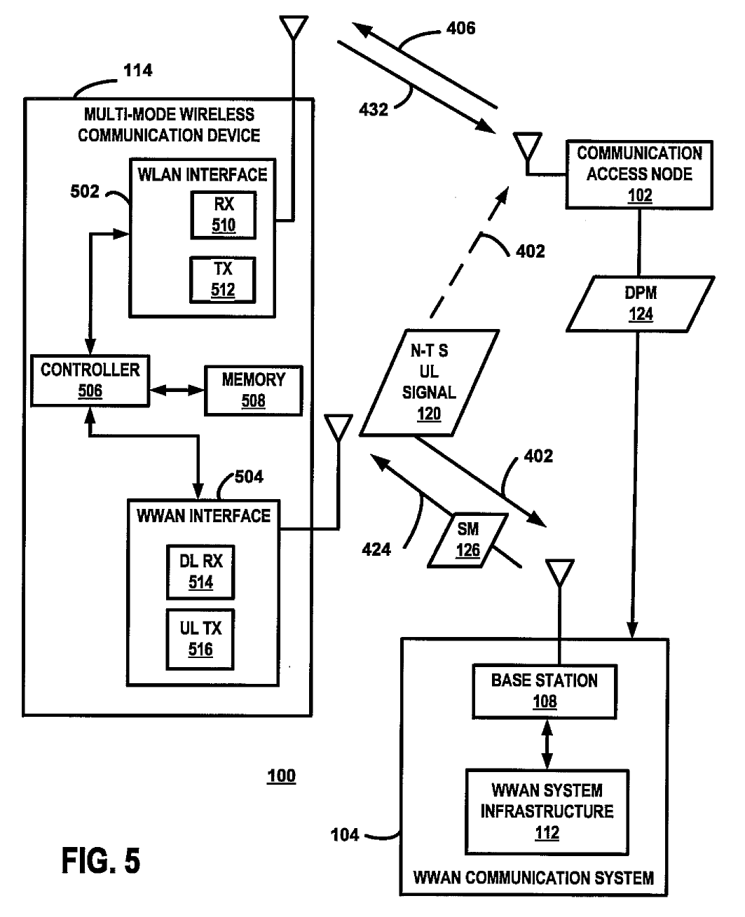

FIG. 5 is a block diagram of a multimode wireless communication device 114 within a communication system arrangement 100. The multimode wireless communication device 114 comprises functionality implemented with any combination of hardware, software and firmware that is capable of communicating with at least one access node 102 within a WLAN network 106 and at least one base station 108 within a WWAN network 110. The multimode wireless communication device 114, sometimes referred to as an access terminal, may be a wireless modem, a personal digital assistant, dual mode cellular telephone, or other such device. A suitable implementation of the multimode wireless communication device 114 includes a WLAN interface 502, and a WWAN interface 504 connected to a controller 506 and memory 508. The various functions and operations of the blocks described with reference to the multimode wireless communication device 114 may be implemented in any number of devices, circuits, or elements. Two or more of the functional blocks may be integrated in a single device and the functions described as performed in any single device may be implemented over several devices. For example, at least portions of the functions of the WLAN interface 502 and the WWAN interface 504 may be performed by the controller 506 and/or memory 508. The controller 506 performs the control functions and is configured to activate the WLAN receiver in response to receiving the search message as described herein as well as performing other functions and facilitating the overall operation of the multimode wireless communications device 114. The controller 506 is connected to, or includes, the memory 508 that may include one or more random access memory (RAM) and/or read only memory (ROM) memory devices. The memory 508 may include data, as for example, a device identifier (ID) value, and criteria for determining quality of the received signals, signal quality parameters and any other data. The WLAN interface 502 includes a WLAN transceiver comprising a WLAN downlink receiver 510 and a WLAN uplink transmitter 512. The WWAN interface 504 includes a WWAN transceiver comprising a WWAN downlink receiver 514 and a WWAN uplink transmitter 504. The WLAN receiver 510 receives WLAN downlink signals 406 transmitted from the access node 102 and the WLAN transmitter transmits WLAN uplink signals 432 to the access node 102.

When the multimode wireless communication device is in a non-raffic state, it periodically monitors the WWAN downlink non-traffic state channels by activating and tuning the WWAN downlink (DL) receiver 514 to the appropriate frequency and/or channel. The paging channel, for example, is monitored. The WWAN uplink (UL) transmitter 516 transmits non-traffic state WWAN uplink signals 402 in accordance with known techniques. For example, the UP transmitter 516 may transmit signals that convey information related to a handoff procedure, an acknowledgement procedure, a registration procedure and a resynchronization procedure a network access request and a response message transmission.

In addition to receiving conventional non-traffic state signals, the WWAN downlink receiver 514 receives a search message 126 within a non-traffic state downlink channel such as the paging channel. As explained above, the search message 126 is transmitted by the base station 108 in response to reception of non-traffic uplink signal 120 at the access node 102. The search message is demodulated and decoded the extracted information is processed by the controller 506. The controller 506 adjusts the searching scheme for WLAN service in accordance with the information contained in the search message. In the example, the WLAN receiver 510 is activated and attempts to receive a downlink WLAN signal 406, such as pilot signal, transmitted by the access node 102.

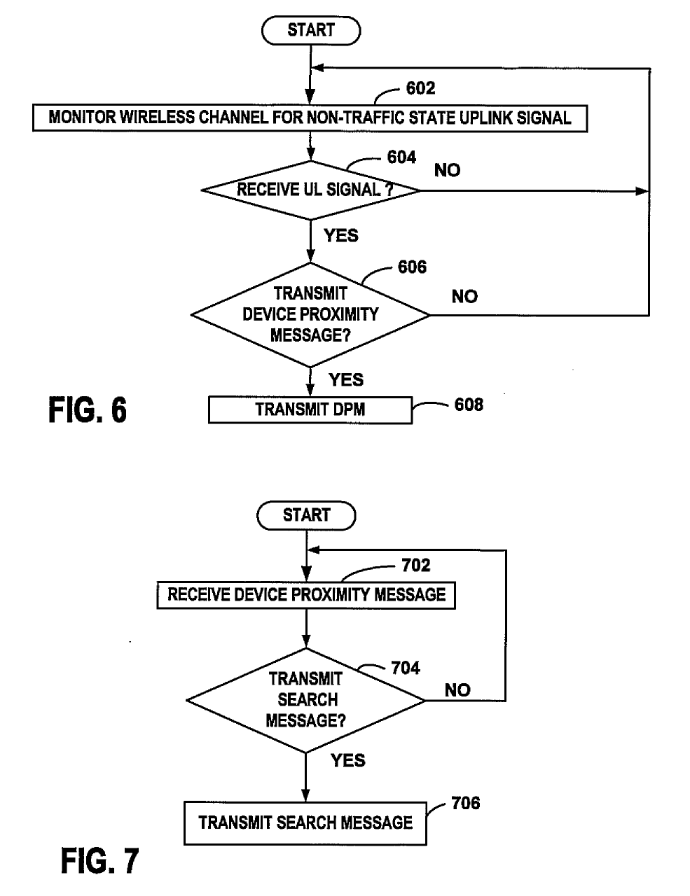

FIG. 6 is flow chart of a method of managing wireless service to a multimode wireless communication device 114 performed at the access node 102. The method may be performed by any combination of hardware, software and/or firmware. The order of the steps discussed below may be varied and one or more steps may be performed simultaneously in some circumstances. In the exemplary embodiment, the method is performed, at least in part, by executing code on the controller 436 in the access node 102.

At step 602, the wireless channel that may contain a non-traffic state uplink signal 120 is monitored. The uplink receiver 418 attempts to demodulate and/or decode incoming signals within the wireless communication channel. In this example, the uplink receiver 418 is tuned to decode any uplink signals 402 transmitted from any of the communication devices 108 in the user list stored in memory 438. The long code masks derived with the device identification values are applied to incoming signals until an incoming non-raffic state uplink signal is detected.

At step 604, it is determined whether a non-traffic state uplink signal 120 has been received. In this example, the controller 436 determines that a non-traffic state uplink signal 120 has been received if an incoming uplink signal can be decoded and determined to be a non-traffic state signal transmitted from an authorized multimode wireless communication device. If a non-traffic state uplink signal 120 has been received, the method continues at step 606. Otherwise, the method returns to step 602 to continue monitoring the wireless channel.

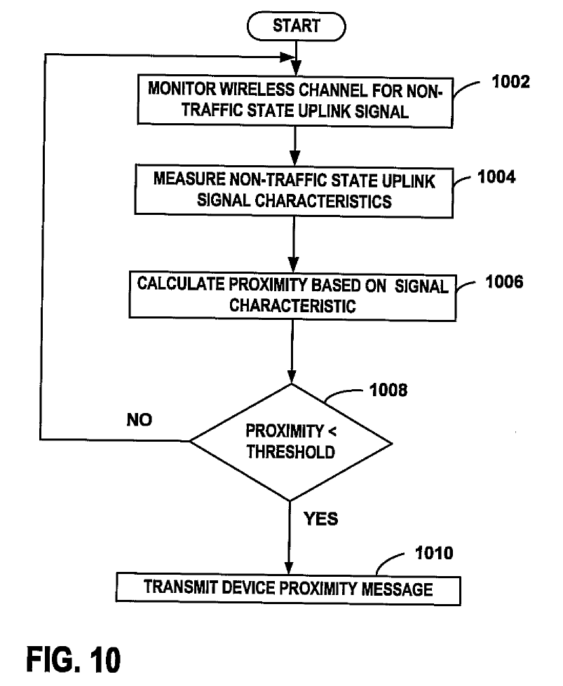

At step 606, it is determined whether the device proximity message 124 should be transmitted. In some situations, step 606 can be omitted and the device proximity message 124 may be transmitted when the non-traffic state signal 120 is detected. This procedure is discussed with reference to FIG. 9. In other situations, however, additional processing or communication is invoked occur before the device proximity message is transmitted. For example, system conditions of the access node 102, other access nodes, other base stations, the core network, and/or alternate networks can be evaluated to determine whether a handoff to the access node 102 is desired. An example of such a procedure is discussed with reference to FIG. 10. If it is determined that the device proximity message 124 should be transmitted, the method continues at step 608. Otherwise, the method returns to step 602.

At step 608, the device proximity message 124 is sent to the system infrastructure. The device proximity message 124 at least identifies the multimode wireless communication device 114 and indicates that the device 114 may be within, or near, the service area of the access node 102.

FIG. 7 is a flow chart of a method of managing communication services to the multimode wireless communication device 114 performed in the system infrastructure. The method may be performed by any combination of hardware, software and/or firmware. The order of the steps discussed below may be varied and one or more steps may be performed simultaneously in some circumstances. In this example, the method is performed, at least in part, by executing code on the controller 118 in the WWAN system infrastructure 112.

At step 702, the device proximity message is received from the access node 102. As described above, the device proximity message is sent through the IP network and routed through the access gateway to the controller 118. The controller 118 extracts information from the device proximity message 124 which includes at least information identifying the multimode wireless communication device 114.

At step 704, it is determined whether the search message 126 should be transmitted to the multimode wireless communication device 114. The controller 118 may evaluate any number of factors in accordance with known techniques for managing handoffs and communication resources in determining whether to transmit the search message. In some circumstances, as described with reference to FIG. 9, the threshold may be relatively low and the controller determines to send the search message solely in response to receiving the device proximity message. In other circumstances, the controller 118 may apply the same criteria as used to determine whether to handoff a device from one base station to another. Some examples of criteria that may be evaluated by the controller 118 include bandwidth requirements, capacity of the base stations, QoS levels priority levels, and costs. If the controller determines that the search message should be sent, the procedure continues at step 706. Otherwise, the method returns to step 702.

At step 706, the search message is generated and transmitted to the multimode wireless communication device 114. The controller 118 generates a search message in accordance with page messaging techniques. As discussed above, the search message includes information for adapting the search parameters of the base station searching scheme used by the multimode wireless communication device. When the invoking the changes contained in the search message, the multimode wireless communication device increases the likelihood of detecting the access node 102 in a shorter time than if the changes are not made. The search message is transmitted from the macro base station.

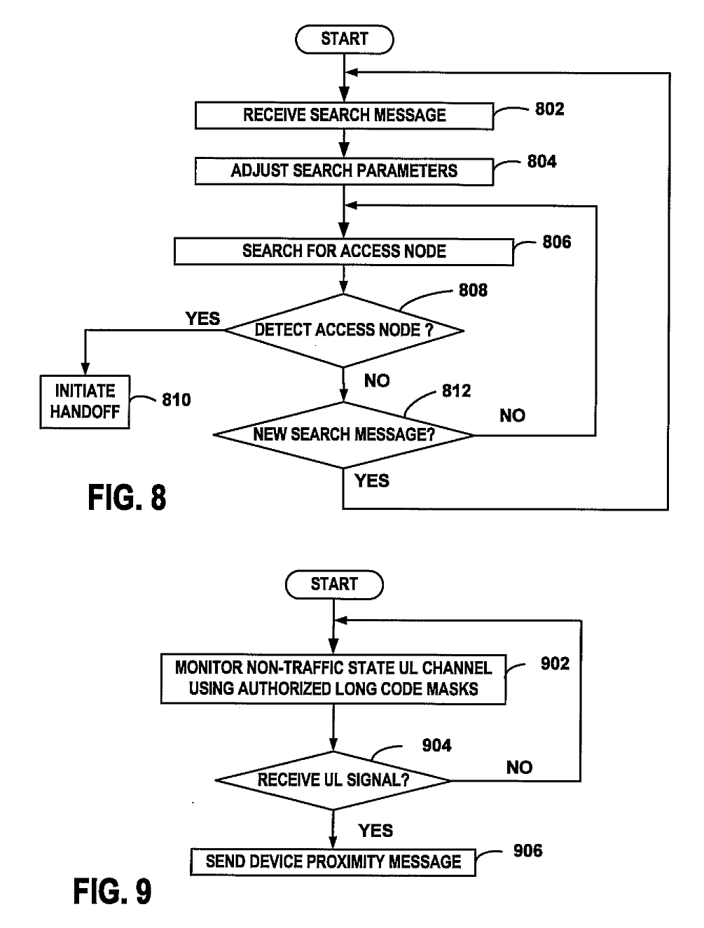

FIG. 8 is a flow chart of method performed at the multimode wireless communication device after receiving the search message. The method is performed, at least partially, by executing code on the controller 436 in the multimode wireless communication device 114.

At step 802, the search message 124 is received. In accordance with know techniques, the multimode wireless communication device periodically monitors the downlink paging channels to receive control messaging from the WWAN system infrastructure 112 during the non-traffic state. The search message is received and deciphered to extract the information related changes to the search parameters.

At step 804, the changes included in the search message are applied to the search scheme of the wireless communication. For the example, the search message invokes activation of the WLAN receiver 510 in step 806. Accordingly, the controller 506 supplies the appropriate control signals and information to the WLAN receiver 510.

At step 806, the newly applied search parameters are applied in searching for an alternate base station. The multimode wireless communication device 114 tunes a downlink receiver in accordance to the searching scheme to search for a pilot signal transmitted from the access node 102. In some circumstances, the multimode wireless communication device may search for beacons or other signals transmitted from the access node 102.

At step 808, it is determined whether the base station 108 has been detected. If a signal from the access node 102 is detected, the method continues at step 810, where handoff is initiated in accordance with known techniques. Otherwise, the method continues at step 812.

At step 810, it is determined whether a new search message is being transmitted. If so, the method returns to step 802 to receive the new search message. Otherwise, the method returns to step 806 to continue searching for the access node 102.

FIG. 9 is a flow chart of a method of managing communications performed at an access node 102 where the device proximity message is transmitted in response to receiving the non-traffic station uplink signal from an authorized multimode wireless communication device 114. The method of FIG. 9 provides an example of monitoring the non-traffic state uplink channels. Other techniques may be used in some situations. The method may be performed by any combination of hardware, software and/or firmware. The order of the steps discussed below may be varied and one or more steps may be performed simultaneously in some circumstances. In the exemplary embodiment, the method is performed, at least in part, by executing code on the controller 436 in the access node 102.

At step 902, the non-traffic state uplink channels are monitored for a non-traffic state uplink signal that is transmitted with a PLCM corresponding to an authorized communication device in the user list stored in memory of the access node 102. The multimode wireless communication device uplink receiver 114 attempts to decode incoming signals using the PLCM derived from the device identification values. The device identifiers, such as ESNs, MEIDs, or IMSIs, are applied in accordance with known techniques and the convention of the macrocell base station 108 to generate a PLCM for each authorized device. Demodulated signals are decoded using the PLCMs to attempt to decode the incoming signals. In some cases the PLCM maybe assigned by the base station 108.

At step 904, it is determined if a non-traffic state uplink signal has been received from an authorized multimode wireless communication device 114. If an incoming signal is successfully decoded, the controller 436 determines that the non-traffic state uplink signal 120 has been received and transmits the device proximity message at step 906. Otherwise, the method returns to step 902 to continue monitoring the uplink channels.

FIG. 10 is a flow chart of a method of managing communications where the proximity of the multimode wireless communication device 114 to the access node 102 is determined based on the non-traffic state uplink signal. The method may be performed by any combination of hardware, software and/or firmware. The order of the steps discussed below may be varied and one or more steps may be performed simultaneously in some circumstances. In the exemplary embodiment, the method is performed, at least in part, by executing code on the controller 436 in the access node 102. The method described with reference to FIG. 10 provides an alternative to technique of FIG. 9 where the device proximity message is sent in response to successfully decoding the non-traffic state uplink signal.

At step 1002, the wireless channel that may contain the non-traffic state uplink signal is monitored. The WWAN uplink receiver 418 in the WWAN interface 122 attempts to demodulate and/or decode incoming signals within the non-traffic WWAN uplink channel.

At step 1004, a characteristic of the non-traffic state uplink signal is measured. One or more parameters such as power level or signal travel time are measured.

At step 1006, the proximity of the communication device 114 to the access node 102 is calculated. The proximity calculation may be based on any number of parameters or characteristics of the received non-traffic state signal as well as other factors. Examples of suitable parameters include parameters related to signal power level and a timing offset between a transmission and reception times. Other related factors may include transmission power level, location of one or more base stations and information extracted from detection signal and downlink signals such as time stamps, power level indicators, and. In some circumstances, the proximity is based only on a detection of the uplink signal as discussed with reference to FIG. 9. The particular factors and calculation techniques depend on the type of communication system arrangement 100.

At step 1008, it is determined whether the communication device 114 is close enough to the access node 102 to justify transmitting the device proximity message 124. The calculated proximity is compared to a proximity threshold. If the estimated proximity is less than the threshold, the method continues at step 1010 where the device proximity message 124 is transmitted. Otherwise, the method returns to step 1002. In some circumstances, this step may be omitted and the access node 102 may send proximity information to the core network with other information to allow the WWAN system infrastructure to make the determination of whether a communication device 114 should acquire service from the access node 102 and whether the WWAN base station 108 should transmit the search message 126.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. An access node comprising:
a wireless local area network (WLAN) interface configured to exchange WLAN signals with a multimode wireless communication device; and
a wireless wide area network (WWAN) interface configured to detect a non-traffic state uplink signal transmitted to a WWAN from the multimode wireless communication device while the multimode wireless communication device is in a non-traffic state.

2. The access node of claim 1, wherein the WWAN interface comprises a communication interface configured to transmit a device proximity message at least indicating that the non-traffic state uplink signal was received from the multimode wireless communication device at the access node.

3. The access node of claim 2, wherein:
the WLAN interface comprises a WLAN transceiver; and
the WWAN interface comprises a WWAN receiver.

4. The access node of claim 3, wherein the device proximity message invokes transmission of a search message instructing the multimode wireless communication device to adjust a search scheme for an alternate access node.

5. The access node of claim 4, wherein the search message instructs the multimode wireless communication device to search for an access node signal transmitted by the access node.

6. The access node of claim 4, wherein the search message instructs the multimode wireless communication device to activate a WLAN receiver within the multimode wireless communication device.

7. The access node of claim 6, wherein the device proximity message invokes transmission of the search message from a WWAN base station of the WWAN through a non-traffic state downlink channel to the multimode wireless communication device.

8. The access node of claim 7, wherein the non-traffic state uplink signal comprises information related to at least one of a handoff procedure, an acknowledgement procedure, a registration procedure, a resynchronization procedure, a network access request, and a response message transmission.

9. A wireless communication system comprising:
a wireless wide area network (WWAN) base station; and
an access node configured to receive, a non-traffic state uplink signal transmitted to the WWAN base station from a multimode wireless communication device in a non-traffic state, the WWAN base station configured to transmit a search message instructing the multimode wireless communication device to search for an access node signal in response to the access node receiving the non-traffic state uplink signal.

10. The wireless communication system of claim 9, wherein the access node is further configured to send a device proximity message to a WWAN infrastructure connected to the WWAN base station, the device proximity message indicating at least that the non-traffic state uplink signal was received the access node.

11. The multimode wireless communication device of claim 10, wherein the device proximity message indicates a proximity of the multimode wireless communication device to the access node.

12. The wireless communication system of claim 9, wherein the search message instructs the multimode wireless communication device to search for an access node signal transmitted by the access node.

13. The wireless communication system of claim 12, wherein the WWAN base station is configured to transmit the search message to the multimode wireless communication device using a non-traffic state downlink channel.

14. The wireless communication system of claim 13, wherein the non-traffic state uplink signal comprises information related to at least one of a handoff procedure, an acknowledgement procedure, a registration procedure, a resynchronization procedure, a network access request, and a response message transmission.

15. The wireless communication system of claim 9, wherein the search message instructs the multimode wireless communication device to activate a WLAN receiver.

16. A multimode wireless communication device capable of communicating within at least a wireless wide area network (WWAN) and a wireless local area network (WLAN), the multimode wireless communication device comprising:
a WWAN transmitter configured to transmit a non-traffic state uplink signal to a WWAN base station when the multimode wireless communication device is a non-traffic state;
a WWAN receiver configured to receive a search message from the WWAN base station transmitted in response to reception of the non-traffic state uplink signal at an access node within the WLAN; and
a WLAN receiver configured to search, in response to receiving the search message, for an access node signal.

17. A multimode wireless communication device of claim 16, wherein the WLAN receiver is configured to search for an access node signal transmitted from the access node.

18. A multimode wireless communication device of claim 16, further comprising a controller configured to activate the WLAN receiver in response to receiving the search message.

19. The multimode wireless communication device of claim 16, wherein the WWAN receiver is configured to receive the search message through a paging channel.

20. The multimode wireless communication device of claim 16, wherein the non-traffic state uplink signal comprises information related to at least one of a handoff procedure, an acknowledgement procedure, a registration procedure, a resynchronization procedure, a network access request, and a response message transmission.
